(19) United States
(12) Patent Application Publication
(10) Pub. No.: US 2003/0050969 A1
(43) Pub. Date: Mar. 13, 2003

(54) Information integration system

(76) Inventors: Philip Anthony Sant, London (GB); Mark Stephen Knight, London (GB)

Correspondence Address: Jeffrey M. Kaden, GOTTLIEB, RACKMAN & REISMAN, P.C., 270 MADISON AVENUE, NEW YORK, NY, 10016-0601, US

(21) Appl. No.: 09/954,977

(22) Filed: Sep. 17, 2001

(30) Foreign Application Priority Data
Mar. 20, 2001 (GB) 0106962.4
Jun. 12, 2001 (GB) 0114281.9

(51) Int. Cl. G06F 17/24; G06F 17/21; G06F 17/00; G06F 15/00; G06F 15/16

(52) U.S. Cl. 709/203; 707/501.1

(57) ABSTRACT

An information integration method for integrating the information content of a plurality of information servers, the method comprising:

generating a user interface for accessing the information at the plurality of information servers and for receiving requests for information;

retrieving information from a plurality of information servers in response to a received request;

determining segments of information required in the information retrieved from each information server in response to the received request; and

combining a plurality of determined information segments from a plurality of information servers in response to a received request to generate a combined information output.

### FIELD OF THE INVENTION

The present invention generally relates to an information integration system for integrating information available from a plurality of information servers.

### BACKGROUND OF THE INVENTION

Many companies have some legacy systems which are used by various people for specific purposes. Typically these are dedicated systems including such things as enterprise resources planning (ERP) for a line of business (LOB) systems. Large corporations tend to have a large number of legacy systems some of which can be web enabled and some not.

Prior art methods for integration of such systems require interfacing to be implemented at code level to gain access to the core functionality of the legacy systems. These systems which have been web enabled are likely to have been web enabled using different techniques. Thus the company cannot obtain integrated access to the core functionality of the legacy systems and a single view or portal cannot be provided.

### SUMMARY OF THE INVENTION

It is an object of the present invention to provide an improved information integration system to integrate information available from a plurality of applications or information servers.

In accordance with one aspect the present invention provides an information integration system for integrating the information content of at least one information server in which a user interface is provided for accessing the information at the or each information server. The user interface provides a single view into the information servers to allow information to be retrieved and requests to be input. Thus the user interface acts as a single portal into the system and it can thus be managed to provide a consistent view of the information. Means is provided for retrieving information from the or each information servers in response to a received requests. In accordance with this aspect of the present invention, the information required in response to the request can be obtained from the information servers. The segments of information return from each of the information servers is then identified and combined to form the response to the request. In this way information can be composited, consolidated, or aggregated from a number of different sources or information can be repositioned, repurposed or rebranded for display. In this way the disparate nature of the information or application servers is not visible to a user: a single view of all of the information at the servers is provided to the user.

In one embodiment of the present invention, information templates are stored and selectively used for the combination of the information segments in order to generate the response to a request from the user. In this way the layout and format of the information returned to the user can be predefined in accordance with the stored information templates.

In an embodiment of the present invention, the information to be retrieved is formatted in accordance with a mark up language such as hypertext mark up language (HTML) or extensible mark up language (XML). Thus in this embodiment the segments of information can be determined by identifying tags in the mark up language. In one embodiment these tags can be added to the dynamically generated mark up language output available from an application server before being received by the information integration system. Thus in this embodiment the web application implemented at the application server performs a tag processing operation to analyse the dynamically generated mark up language and to add segment tags for use by the information integration system. In an alternative embodiment, the information integration system can identify the normal tags used in the mark up language. This is particularly the case when XML is used.

The present invention also encompasses any means of determining the segments such as the use of markers within the information, or the parsing of the information in accordance with rules or an algorithm in order to determine the segments. The present invention is however particularly suited to mark up languages where tags are already available and can be specifically assigned for segment identification.

The present invention is applicable to any type of information in an electronic form such as text (including text formatted in accordance with a mark up language such as HTML, XML, VRML, WML, Voice XML, SMIL etc and code such as Java.), video, images, data, or computer programs. This aspect of the present invention enables the aggregation of segments of information into an output to be presented to the user without the user being aware of the disparate nature of the information sources behind the information integration system.

The present invention is particularly suited to information sources which comprise application servers for dynamically generating the information. Since the information is generated dynamically, it cannot be archived at the information integration system and must be retrieved from the application server when a request is made to it. In this way the information integration system is able to utilise the core functionality of the legacy systems in an integrated information providing system and preserve business logic.

In a preferred embodiment, the integration is an integration of web enabled legacy systems where each information source is web enabled to generate web page outputs in response to requests. The information integration system is networked to the information servers to communicate using the hypertext transfer protocol (HTTP). The information integration system acts as a web client to the information servers and as a web server to the users. It thus performs a web proxy operation in order to integrate the information available at the legacy information servers. It does this by using simple web technology which requires no understanding of the code implemented at the information servers.

In one embodiment of the present invention, events performed when requests are received from the user are stored. Events caused as a result of requests received from a user are recorded in order to provide state information for a user. The provision of state information enabling path analysis, time stamp recordal and stateful logging of user context information when events are recorded and identified is significantly different to conventional web servers since the web protocol (HTTP) is essentially a stateless protocol, The use of stored events called as a result of a request by a user enables state information to be used and recorded in the system. The recordal of state information enables the recordal of events for use in management functions. This provides a reporting function within the system.

In one embodiment of the present invention, user information is stored such as personal information e.g. name, age salary etc. The user information can include information server logon information as well system logon information. When a user logs on to the system, the system can use the stored user information to enable it to log on to the information servers when this is necessary in order to retrieve information from the information servers in order to respond to the request from the user. Thus this facility provides the user with a single logon and avoids the user having to log on to the multiple legacy information servers independently. The log on information for the information servers will be used as necessary and when necessary to respond to the user's request.

Another aspect of the present invention provides an information interface in which a user interface is provided to receive requests from the user and output information, Information is presented to the user from a plurality of information locations. The information locations can comprise separate information servers or separate information files in different logical locations. The logical locations can be the same physical location or different physical locations e.g on machines networked over a local area network, wide area network, or the internet. Where a request is received from the user, information from the information locations is retrieved and predetermined mark up tags are identified to identify items included in the output to the user.

This aspect of the present invention provides the means by which information can be aggregated from a number of information sources without requiring any input or knowledge from the user.

A further aspect of the present invention provides an information integration system for integrating applications at a plurality of application servers. A IP interface is used to enable IP to be used as the communication protocol between the information integration system and the application servers. Each application server has an IP application for receiving IP requests from the integration system and for outputting IP content. Received IP content from the application servers is processed and formatted according to a predefined format for output by a IP server as a web interface to users. This aspect of the present invention enables the control of the format to provide a single format type of user interface to a user for information retrieved from all of the application servers. Thus in this way the system acts as a single portal to the application servers.

This aspect of the present invention is applicable to any IP protocol such as the HTTP protocol, the SMTP protocol and the FTP protocol all of which are carried by the IP protocol.

The present invention can be implemented in dedicated hardware, in a combination of dedicated hardware and programmable hardware, or in programmable hardware alone. The present invention thus encompasses computer programs for controlling programmable hardware. The present invention-encompasses any carrier medium carrying the computer program such as a storage medium (e.g. a floppy disk, hard disk, CD rom, programmable logic device, or tape device) or a transient medium (e.g. a microwave, optical, electrical, or radio frequency signal) carrying the computer code. For example the carrying medium can comprise a signal (a TCP/IP signal) carrying computer code over an internet protocol network such as the internet or a local area network.

### BRIEF DESCRIPTION OF THE DRAWINGS

Embodiments of the present invention will now be described with reference to the accompanying drawings in which:

FIG. 1 is a schematic diagram of an information integration system in accordance with an embodiment of the present invention,

FIG. 2 is a more detailed schematic diagram of the information integration system in accordance with an embodiment of the present invention,

FIG. 3 is a more detailed different schematic diagram of the information integration system in accordance with an embodiment of the present invention,

FIG. 4 is a flow diagram illustrating the operation of the system in accordance with an embodiment of the present invention,

FIG. 5 is a schematic diagram of the operation of the user identification module in the information integration system of an embodiment of the present invention,

FIG. 6 is a diagram illustrating the various methods of forming web pages in the information integration system in accordance with an embodiment of the present invention, and

FIG. 7 is a diagram illustrating the input of form data and submission of the form data to the application server to generate a result as a web page in accordance with an embodiment of the present invention.

### DETAILED DESCRIPTION

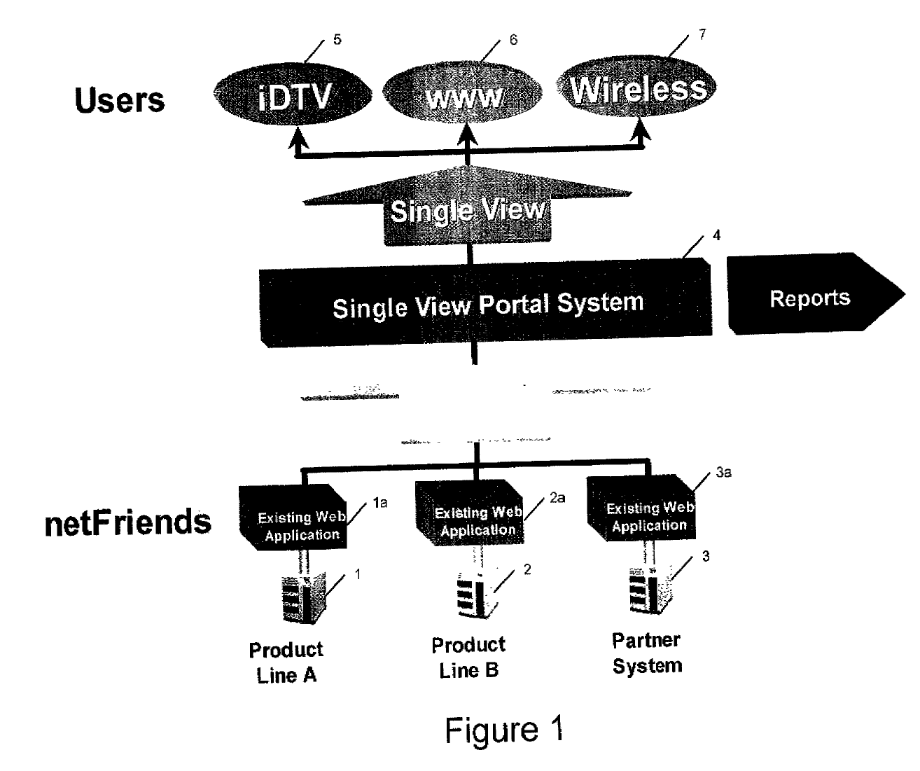

FIG. 1 schematically illustrates the principles of the present invention. Three legacy systems 1, 2 and 3 implement applications and contain data which is to be accessed by users. Each system 1, 2 and 3 is web enabled and is provided with a web application 1a, 2a and 3a. Thus each system is capable of receiving HTTP requests and generating web pages in response. Each system is termed in this embodiment a netFriend. The system of this embodiment of the present invention provides integration of the information at each system 1, 2 and 3 to provide a single view portal system 4 to provide a single view as an internet (web) view to a plurality of possible devices such as a digital TV 5, a web browser 6, or a wireless device 7 such as a wireless application protocol (WAP) device.

This embodiment of the present invention thus integrates the web capabilities of the systems 1, 2 and 3 to provide a single view to users of the system without the users being involved in the process. The single view portal system 4 also enables reports on the actions of users to be obtained for management purposes.

Each legacy system 1, 2 and 3 with its web application 1a, 2a and 3a can each have a number of static content pages and a number of transactional or dynamic pages. Each page has a specific universal resource locator (URL) and its output from the web application 1a, 2a or 3a in response to an HTTP request to the URL.

The purpose of this embodiment of the present invention is to provide a single view into the web pages which is managed and controlled.

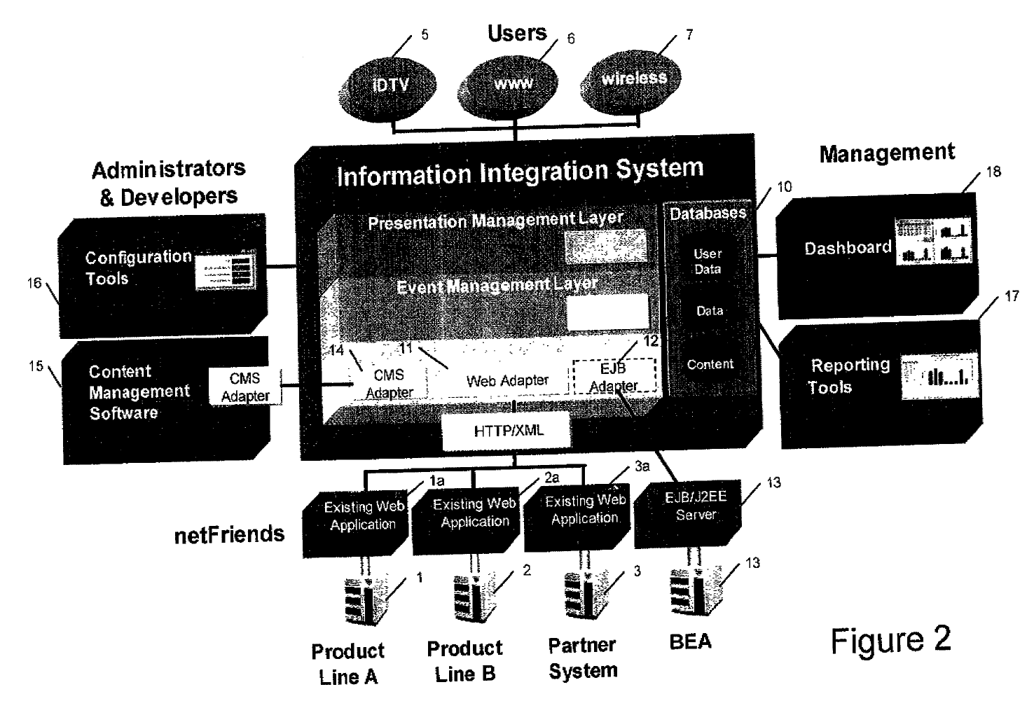

FIG. 2 illustrates the information integration system in more detail.

The information integration system operates to provide a presentation management layer which includes the ability to identify users and interact with a user data base 10. An event management layer is also provided to operate in accordance with an event model. Adaptors are provided for interaction with external devices. A web adaptor 11 is provided to provide a web interface to the application servers 1, 2 and 3 an Enterprise Java Bean (EJB) adaptor 12 is provided for connection to EJB server 13 acting as an application server for the performance of calculations. Results can thus be returned and used in a generation of an output to users. Content Management System (CMS) adaptor 14 is provided for connection to a content management system 15 to provide content management within the information integration system.

The information integration system is also provided with configuration tools 16 to enable the system to be configured. Reporting tools 17 are also provided to provide management reports on events within the information integration system. A dash board user interface 18 is provided as an interface to the management information available from the information integration system.

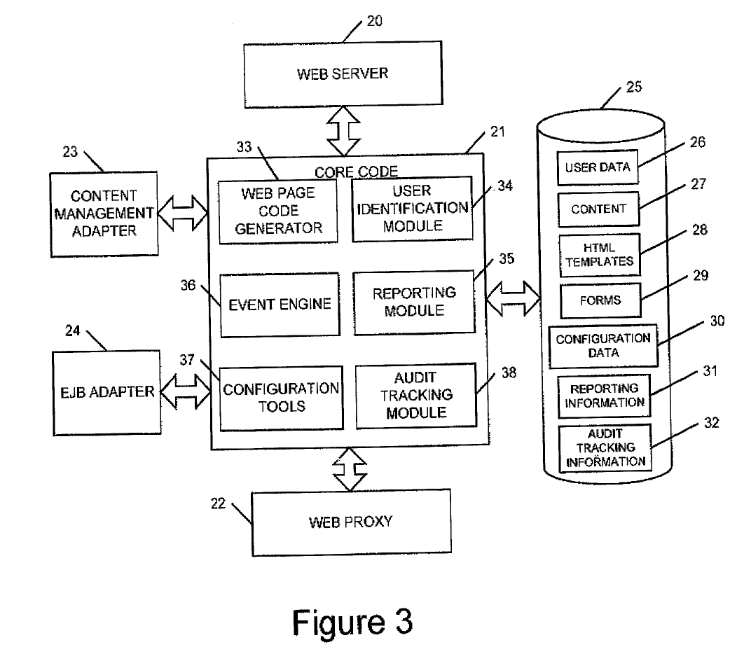

FIG. 3 is a schematic diagram illustrating the structure of the information integration system in more detail.

A web server 20 is provided to provide the user interface to the system. The web server will receive HTTP requests and will respond with HTML output from the core code 21. The core code 21 comprises 6 modules:

1. A web page code generator performs the function of generating HTML using HTML templates 28 in the database 25 and using content 27 stored in the database 25. The content can comprise static HTML provided from the application servers 1, 2 and 3 and items comprising segments of HTML. code extracted from web pages returned from the application servers 1, 2 and 3.

2. A user identification module 34 is provided to implement a logon sequence for the user and uses the user data 26 in the database 25.

3. An event engine 36 is provided for implementing events read from the configuration data 30 in database 25.

4. A reporting module 35 is provided to monitor events and generate reporting information 31 stored in the database 25.

5. Configuration tools 37 are provided for the generation and modification of configuration data 30. The configuration data will be described in more detail hereinafter.

6. An audit tracking module 38 is provided to provide an audit trail or audit tracking information 32 in the database 25 to monitor management functions such as the reconfiguration of the system.

A web proxy 22 is provided which acts as a web client to the application servers 1, 2 and 3 and a web server to the core code 21. The web proxy generates HTML requests to retrieve information from the application servers 1, 2 and 3 and receives HTML which is served to the core code 21.

A content management adaptor 23 is provided to allow a content management system 15 to be interfaced to the system. The content management system conveniently comprises a content management programme for the management of the content within the system.

The EJB adaptor 24 is provided to interface to a EJB server 13 for the performance of calculations. Results can be returned and used within the core code 21 in the generation of the output web page served by the web server 20.

It must be seen from FIG. 3 that the database 25 holds a large amount of data. The user data 26 contains information on the user such as login information and personal information. Login information includes not just login information to access the system but also login information to gain access to each of the application servers 1, 2 and 3. The login information for the system and for the application servers 1, 2 and 3 is related such that when a user is logged in to the system, the login information for the application servers can be used to log in to the application servers when necessary. Thus when a customer logs in to the system, it would seem to them that they are automatically logged in to all of the application servers 1, 2 and 3. The log in to the system and the log in to the application servers can be implemented using any conventional technique. The system can be implemented using:

1. persistent cookies in which a single cookie stored on the user's machine can identify them automatically,

2. HTTP authentication in which the standard login mechanism built into the user's internet browser is used to enable a user to login by entering the user name and password into a browser supplied pop-up window, and

3. forms based login using a form generated for the input of information by the user.

The content 27 held within the database 25, in this embodiment comprises HTML and other web page content. The HTML can be in the form of static web pages which may or may not be modified in accordance with a template stored in the HTML template 28. The HTML stored in the content 27 is not modified in accordance with an HTML template 28, it can be so modified by the web page code generator 33 before output of the web page by the web server in response to an HTTP request. The content 27 can also include items in the form of segments of HTML. The segments of HTML (Items) in this embodiment are identified using tagging.

When the system is being configured, application servers are identified and are entered into the database as netFriends in the configuration data 304 Transactional or dynamic and static web pages are identified that are provided by the netFriend. Static web pages are copied into the content 27 in the database 25. They can be modified by the web page code generator 33 using HTML template 28 to be ready for output directly to the web server 20. Alternatively, they can be stored in “raw” form to which an appropriate HTML template can be applied from the HTML templates 28.

For transactional pages, metadata is created within the configuration data 30 to identify the netFriend, the URL and events associated with each transactional page.

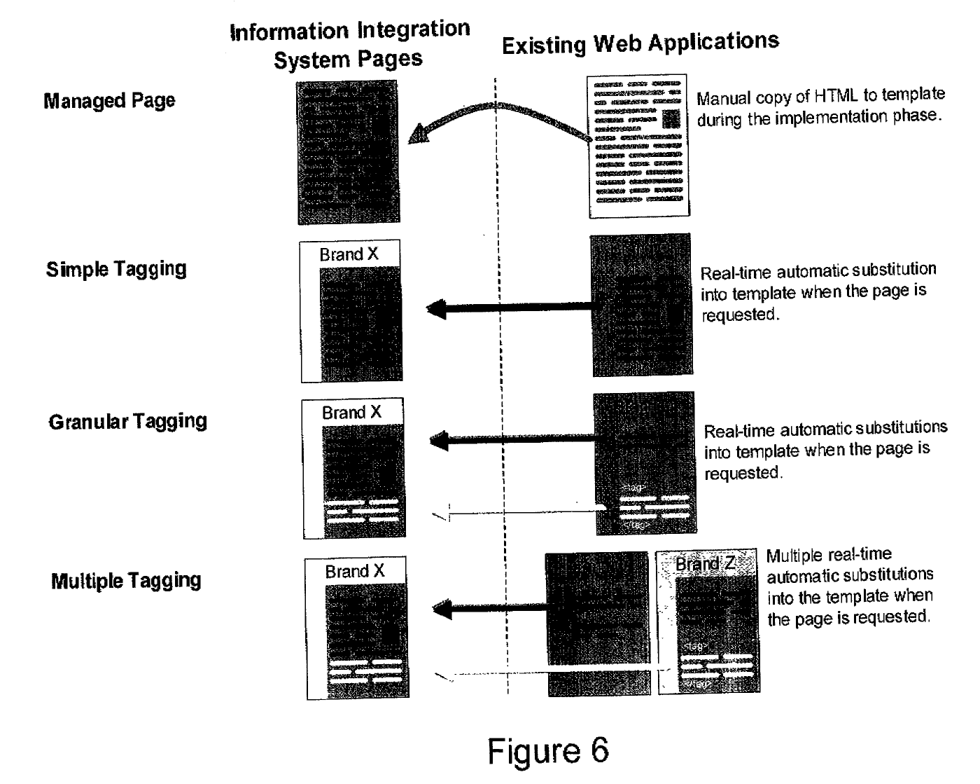

In this embodiment of the present invention, the content on the transactional pages are described using a simple mark up language. FIG. 6 schematically illustrates the different methods used by the system to generate web pages using the output of the existing web applications. A managed page can be generated simply by manually copying the HTML to a template during the implementation phase. Thus in this method a complete copy of the HTML is used and subjected to a template operation. In a simple tagging method two tags are used to encapsulate the segment of HTML for automatic substitution into a template. Granular tagging can be used for the extraction of a number of small segments on the same web page. It is also possible to use multiple tagging wherein segments are tagged in more than one web page and are combined into one web page for output from the information integration system.

The tagging system of this embodiment of the present invention only requires the output of the legacy system i.e. the application servers to be modified. This provides for simple modification without requiring complexity.

The tagging language syntax will now be described in more detail.

The tagging system has been developed for implementation in the assignees earlier system call BladeRunner. The tags have been labelled netFriends tags.

There are two tags that relate to the mark-up of pages on a legacy web server: the system tag and the item tag. The system tag must appear in the page header. The item tag can appear in the body text or the header area. The following table shows each tag's attributes and provides a brief description:

| Tag | Attribute | Purpose |
|---|---|---|
| <netfriend:system /> | name | the name of the legacy web system |
| | page | the name of the legacy web page |
| | version | the version number of the legacy |
| | | web page |
| <netfriend:item> | name | the name of an area of text or data |

Tag Syntax

The system tag is present on a page and for the system to recognise it and it has three attributes: name, page and version. The syntax is:

<netfriend:system name=“LEGACY_NAME” page=“PAGE_NAME”
version=“X,X” />

The system tag poses a problem for systems that deliver web pages dynamically (for example, through a CGI program, web servelet or HTTP server thread). Depending on the program, a page is either a template (for example, ASP) or generated by a program (for example, CGI). If the page is a template, the system tag must be inserted at the top of the template. If the page is a program, the program must be altered to output the system tag at the beginning.

The name attribute must match the name defined in the database. The page will not be recognised as part of the legacy web system otherwise.

The page attribute is a local name for the page being delivered. The name should be short yet descriptive.

The version attribute defines the version of the legacy web page. Currently, this attribute may contain anything and it is not currently implemented.

The item tag surrounds the HTML that contains data items. Its syntax is:

<netfriend:item name=“ITEM_NAME”>

. . . text/markup . . .

</netfriend:item>

The item tag identifies and labels an area of text or data that may be incorporated into a page or referenced in an event. It can be used as many times as there are data items. It has one attribute—name—which should correspond to the name of a data item that will be used by the system as a container attribute.

An item tag can also accommodate links (either hyperlinks or form submits). The tag must be placed around the entire <A HREF> hyperlink clause in order for the browser to read the page's mark up.

Tag Examples

The following page code shows the tags required in a legacy web page. To assist in identification, the tags appear in bold and this example will appear throughout this document.

<HTML>
<HEAD>
<netfriend:system name=“KNOWLGE_BNK” page=“HLP_INTRO”
version=“1.0” />
<TITLE>Knowledge Bank Help Page</TITLE>
</HEAD>
<BODY>
<netfriend:item name=“WHOLE_TABLE”>

<TABLE border=“1” width=“400”>

<TBODY>

<TR>

<TD>Subject Index</TD>
<TD>You can view this help system via an
index</TD>

</TR>
<TR>

<TD>Search Feature</TD>
<TD>Or you can search for keywords</TD>

</TR>

</TBODY>

</TABLE>

</netfriend:item>
<netfriend:item name=“ENTER_HELP”

<A HREF=“http://131.121.1.5/english_help.html”>
<IMG SRC=“graphics/gotohelp.gif”></A>

</netfriend:item>
</BODY>
</HTML>

Tags for Page Mark-Up

The Information Integration System pages need to extract data that has been tagged in the legacy web pages. A variety of tags exist to enable his process.

All tags must be nested within the <blade:netfriend> opening and closing tags. Three of the nested tags are mandatory: <blade:system>; <blade:page>; and <blade:item>. The remaining four are optional.

| Tag | Purpose |
|---|---|
| <blade:netfriend> | announces that this is a netFriends-specific mark-up. It |
| | encloses all other netFriends tags in the set |
| <blade:system> | must match the content of a <netfriend:system name> |
| | legacy page tag |
| <blade:page> | must match the content of a <netfriend:system page> |
| | legacy page tag |
| <blade:item> | must match the content of a <netfriend:item name> |
| | legacy page tag |
| <blade:links> | required to identify links from legacy pages. Defaults |
| | to NO if not specified |
| <blade:version> | the version number of a legacy web page (should |
| | match the <netfriend:system version> legacy page tag |
| | when implemented) |
| <blade:format> | the name of an optional format handler that can be |
| | used |
| <blade:index> | for selecting one or more lines by index. Line 0 would |
| | be the first line in a set, line 1 the second, and so on |

Tag Syntax

The syntax of the <blade:netfriend> tag is:

<blade:netfriend>

<blade:system>SYSTEM_NAME</blade:system>
<blade:page>PAGE_NAME</blade:page>
<blade:item>ITEM_NAME</blade:item>
<blade:links>YES/NO</blade:links>
<blade:version>X.X</blade:version>
<blade:format>FORMAT_HANDLER</blade:format>
<blade:index>INDEX_IN_TO_ITEM_SET</blade:index>

</blade:netfriend>

The <blade:version>, <blade:format> and <blade:index> tags are optional.

BladeRunner netFriends matches the contents of the three mandatory tags to the contents of the legacy tags as shown here:

[image]

The <blade:version> tag is currently not used. Upon implementation, however, it will parallel the <netfriend:system version> tag of legacy web pages.

Tag Examples

<HTML>
<HEAD>
<TITLE>BladeRunner netFriends Knowledge Bank Help Page</TITLE>
</HEAD>
<BODY>

<blade:netfriend>

blade:system>KNOWLGE_BNK</blade:system>
<blade:page>HLP_INTRO</blade:page>
<blade:version>1.0</blade:version>
<blade:item>WHOLE_TABLE</blade:item>
<blade:item>ENTER_HELP</blade:item>
<blade:links>YES</blade:links>

</blade:friend>

</BODY>
</HTML>

Ensuring Tags Are Inert

If inserted correctly, tags in legacy web pages will remain inert, leaving the original HTML unaffected. This means that if a page is browsed directly (and not through the system), the tags will not influence or affect the original functioning of the legacy system. If a table needs to be included in a tag the syntax should be as follows:

<netfriend:item name=“table”>
<table>

. . . text/markup . . .

</table>
</netfriend:item>

The following table mark-up is an example of bad syntax:

<netfriend:item name=“table open”>
<table>
</netfriend:item>

. . . text/markup . . .

<netfriend:item name=“table close”>
</table>
</netfriend:item>

Although in the present embodiment described hereinabove HTML is used, the present invention also encompasses the use of file formats in which tags are not added For example XML can be used which inherently includes tags which can be identified within the system.

The benefit of the insertion of tags in the web pages of the output of the application servers is that they indicate which system the page is from, and they can identify individual transaction elements on a given page.

In the database 25 configuration data 30 is stored as relational data. The data identifies the legacy systems as netFriends. Each netFriends has net actions (events) associated with it. A net action identifies a net object i.e. the source of information to be retrieved, and the information is identified by a URL. Items available at the URL are also contained in the configuration data and identify transactional items to be retrieved. Configuration data 30 in the database 25 can be configured by administrators using the configuration tools 37. This enables administrators to add legacy systems and to define content pages and items. The relationships between the systems and the actions and items can be automatically generated. Configuration data thus identifies and enables the netFriends to be managed and identifies the corresponding URLs of unique pages within each system. The configuration data also identifies the page templates unto which content and/or data from the legacy system will need to be inserted. Events associated with individual pages and/or content items is also defined.

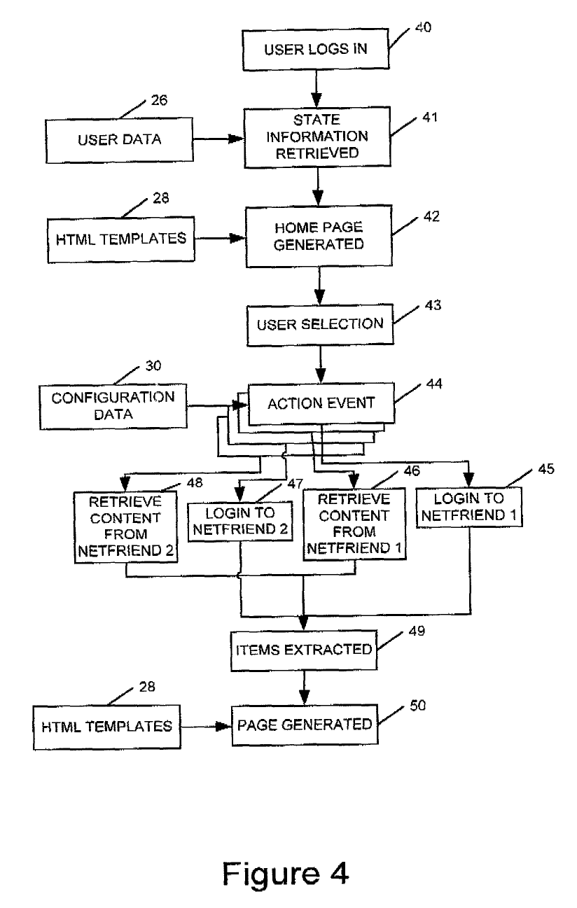

FIG. 4 is a flow diagram illustrating the operation of the system. Initially the user will perform a login (40) to the system. The login can be via a persistent cookie on the user's machine, via a standard HTML login, or using a form accessed by the user. As a result of the input of the login information from the user, either automatically from the cookie or manually, users data 26 is accessed in order to retrieve state information (41) to identify the current state. The state information will include a session ID to identify the current session The user will then be presented (42) with a home page which is generated using the HTML templates 28. The generation of the home page requires state information as well as the HTML templates since the home page will be generated to provide links to events. When a user selects (43) an internet web page, the web server 20 receives an HTTP request which includes an identification of an event. The home page is thus generated to use event information based on state information which includes the user's activity (past and present). Thus when a user selection is made (33) an event 44 is called using information in the configuration data 30. The event can cause a chain of events to occur. In this example the first event (45) is to log in to netFriend 1 the second event (46) is to retrieve content from netFriend 1, the third event (47) is to log into netFriend 2, and the fourth event (48) is to retrieve content from netFriend 2. These actions are predefined in the configuration data and can be set up by the administrator using the configuration tools 37. The results of the actions is retrieval of each HTML content from the application servers 1, 2 and 3. Although in this embodiment it is illustrated that it is necessary to log in to the application servers 1 and 2 (45 and 47), it is also possible for the logins to the application servers to have been performed initially as soon as the user logs in.

The resultant HTML content retrieved from the application servers is processed by parsing to identify the tags and thus identify and extract items (49). The items are added to the content 27 in the database 25. The output web page can then be generated (50) using the items from the content 27 and using the HTML templates 28. Thus in this way the segments of HTML can be extracted from one or more sources and combined in a generated web page output to a user. Web pages generated in accordance with the template to provide a uniform output appearance.

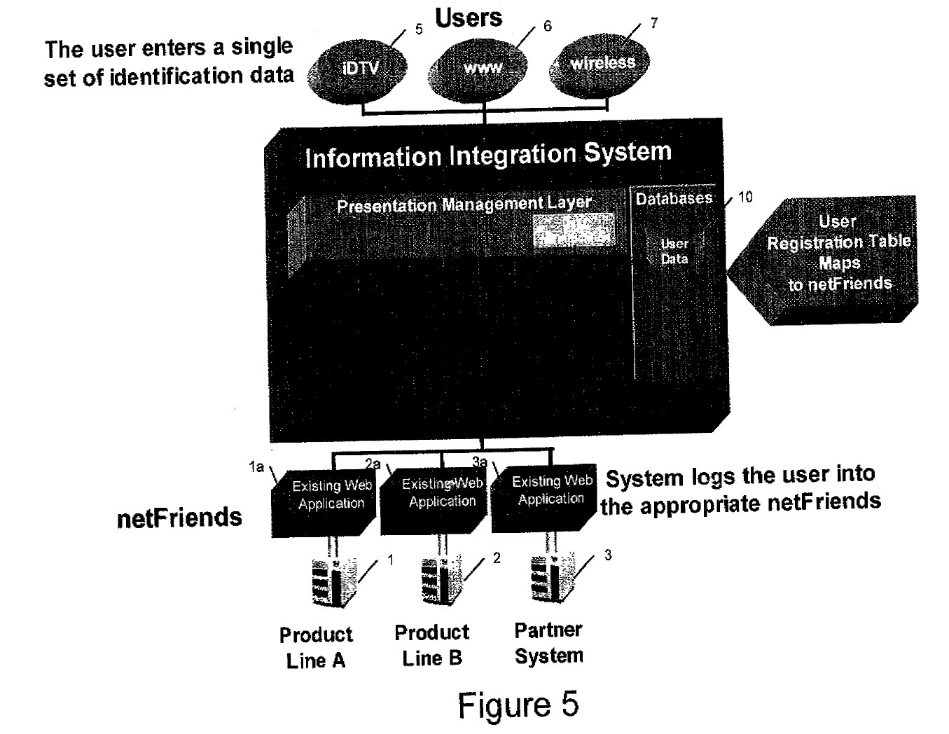

FIG. 5 is a schematic diagram illustrating a process implemented by the user identification module 34. A single set of identification data i.e. logon data is entered by the customer and this is entered into or matched to the information in the user data 10. This user registration table maps to the netFriends in the database. The login information stored in the user database 10 can then be used to login the user to the appropriate netFriends. This can either be done initially, or when necessary, i.e. when information is required from the netFriend.

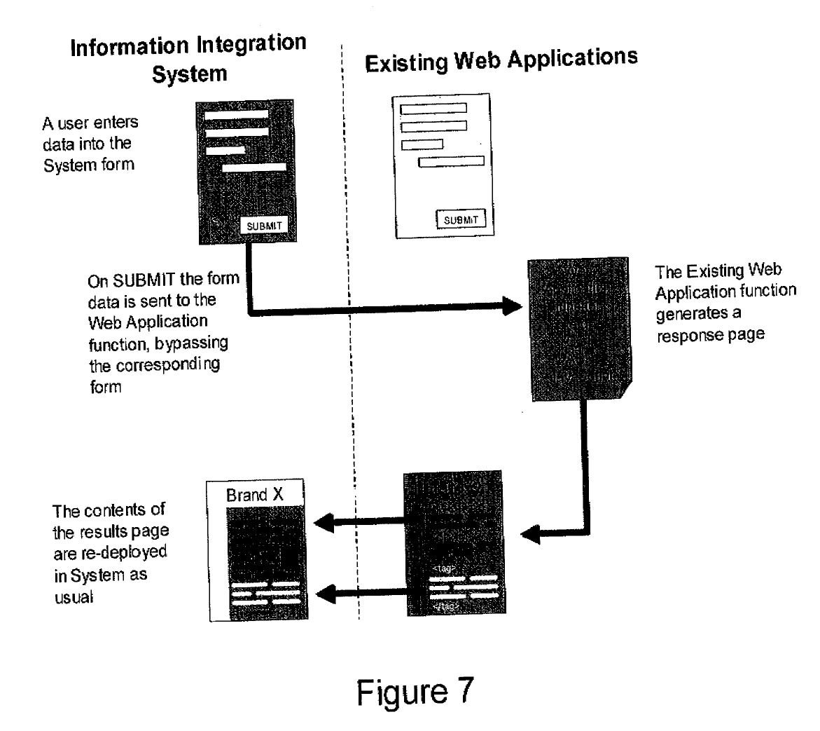

The information integration system stored in the database user information which can be used not just to provide state information, but also to reduce the input required for it the user. FIG. 7 schematically illustrates the input of transaction information to the system web application. Where a user entry is required on a transactional page, the items extracted from the assisting web application web pages can identify the need for user input and a form can be generated by the information integration system. When a user enters data into the system form, the form data is sent directly to the existing web application as an input. An output web page will then be generated which will be tagged in order to generate the results page at the information integration system. Thus in this embodiment the form generated by the existing web application is not to be used and the user need only be familiar with a single style of form generated by the information integration system.

The user's data can be used to prepopulate form fields to reduce the user input. For example, where a number of existing web applications require the same information, this can be stored in the user's database to prepopulate the forms to avoid having to keep re-entering information.

The user's data 26 can be also be used to personalise the web pages generated by the web page code generator 33. For example, a user can select to receive web pages in a particular language. This can be stored in the user's data and this parameter can be used to select the template i.e. the language of the template to be used for the generation of the web page. In this embodiment of the present invention, the user input triggers events in accordance with data stored in the configuration data 30. Thus, it is possible for the reporting module 35 to monitor the events and store reporting information 31. The events that are recorded can identify the user, and the path taken by the user i.e. chain of events. Thus in this way, state information is recorded in the reporting information 31. This provides a rich source of information for administrators and the information is far greater than that provided by conventional web servers which can only provide information which is essentially stateless. The reporting information 31 can be accessed by the administrator using a web interface provided by the web server 20. The reporting module 35 cooperates with the web server 20 to provide the reporting interface for the administrator.

The audit tracking module 28 is provided to monitor management events such as the user of the configuration tools 37. This can provide a fill audit trail for management functions.

Although the present invention has been provided hereinabove with respect to specific embodiments, it will be apparent to a skilled person in the art that modifications lie within the spirit and scope of the present invention.

For example, although the present invention has been described hereinabove with reference to the use of the tagging of information from information servers, the present invention is applicable to any means by which segments of information can be identified. This can include the use of tags, pointers, flags, or any other identifiers. It can also be carried out simply by parsing or analysing the information to identify particular segments.

What is claimed is:

1. An information integration system for integrating the information content of a plurality of information servers, the system comprising:
user interface means for generating a user interface for accessing the information at the plurality of information servers and for receiving requests for information;
information retrieval means for retrieving information from a plurality of information servers in response to a received request;
determining means for determining segments of information required in the information retrieved from each information server in response to the received request; and
combining means for combining a plurality of determined information segments from a plurality of information servers in response to a received request to generate a combined information output.

2. An information integration system according to claim 1, including storage means for storing information templates, wherein said combining means is adapted to combined the information segments in accordance with a said information template.

3. An information integration system according to claim 1, wherein said information is formatted according to a mark-up language, and said determining means is adapted to determine the segments by identifying tags in the mark-up language.

4. An information integration system according to claim 3, where said information from said information servers has tags added to identify the segments, and said determining means is adapted to determine the segments by identifying the added tags.

5. An information integration system according to claim 1, wherein said information at said plurality of information servers includes information dynamically generated by said information servers in response to requests for information from said information retrieval means.

6. An information integration system according to claim 1, wherein said user interface means includes a web server for generating the user interface as web pages and for receiving HTTP requests, and said information retrieval means includes a web proxy for sending HTTP requests for web pages to the information servers in response to HTTP requests received by said web server.

7. An information integration system according to claim 1, including event storage means for storing events to be performed when requests are received, and event recording means for recording events as a result of requests received from users.

8. An information integration system according to any claim 1, including user information storage means for storing user information, wherein said information retrieval means is adapted to use the stored user information for inclusion in requests for information from the plurality of information servers.

9. An information integration system according to claim 1, including user information storage means for storing user logon information for logging on to the plurality of information servers, including logon means for processing a logon request for the system from a user, for using the logon request to identify the user logon information for the plurality of information servers, and for using the identified logon information to logon to the information servers as necessary to allow said information retrieval means to retrieve information from the information servers.

10. An information integration method for integrating the information content of a plurality of information servers, the method comprising:
generating a user interface for accessing the information at the plurality of information servers and for receiving requests for information;
retrieving information from a plurality of information servers in response to a received request;
determining segments of information required in the information retrieved from each information server in response to the received request; and
combining a plurality of determined information segments from a plurality of information servers in response to a received request to generate a combined information output.

11. An information integration method according to claim 10, including storing information templates, and combining the information segments in accordance with a said information template.

12. An information integration method according to claim 10, wherein said information is formatted according to a mark-up language, and the segments are determined by identifying tags in the mark-up language.

13. An information integration method according to claim 12, where said information from said information servers has tags added to identify the segments, and the segments are determined by identifying the added tags.

14. An information integration method according to claim 10, wherein said information at said plurality of information servers includes information dynamically generated by said information servers in response to requests for information from said information retrieval means.

15. An information integration method according to claim 10, wherein a web server is used for generating the user interface as web pages and for receiving HTTP requests, and a web proxy is used for sending HTTP requests for web pages to the information servers in response to HTTP requests received by said web server.

16. An information integration method according to claim 10, including storing events to be performed when requests are received, and recording events as a result of requests received from users.

17. An information integration method according to claim 10, including storing user information, and using the stored user information for inclusion in requests for information from the plurality of information servers.

18. An information integration method according to claim 10, including storing user logon information for logging on to the plurality of information servers, processing a logon request for the system from a user, using the logon request to identify the user logon information for the plurality of information servers, and using the identified logon information to logon to the information servers as necessary to allow said information retrieval means to retrieve information from the information servers.

19. An information interface comprising:
user interface means for generating a user interface and for receiving requests for information in the form of mark-up language;
information retrieval means for retrieving the requested information from the plurality information locations; and
information response generating means for generating the information to be returned to the user by identifying mark-up language items in the retrieved information using predetermined mark-up tags and composing information to be returned to the user by combining identified items.

20. An information interface according to claim 19, wherein the information response generating means is adapted to compose the information to be returned to the user in accordance with at least one predetermined template.

21. An information interface method comprising:
generating a user interface and for receiving requests for information in the form of mark-up language;
retrieving the requested information from the plurality information locations; and
generating the information to be returned to the user by identifying mark-up language items in the retrieved information using predetermined mark-up tags and composing information to be returned to the user by combining identified items.

22. An information interface method according to claim 21, wherein the information to be returned to the user is composed in accordance with at least one predetermined template.

23. An information integration system for integrating applications at a plurality of application servers, the system comprising:
web interface means for interfacing using HTTP to web applications operated by said application servers;
web server means for providing a web interface to users; and
web content processing means for receiving user requests for web content, for controlling said web interface to retrieve web content from at least one application server, for formatting the retrieved web content according to a predefine format, and for returning the formatted web content.

24. An information integration method for integrating applications at a plurality of application servers, the method comprising:
interfacing using HTTP to web applications operated by said application servers;
providing a web interface to users; and
receiving user requests for web content, for controlling said web interface to retrieve web content from at least one application server, for formatting the retrieved web content according to a predefine format, and for returning the formatted web content.

25. A carrier medium carrying computer readable code for controlling a computer to implement the method according to any one of claims 10 to 18, 21, 22, or 24.
